(19) United States
(12) Patent Application Publication
(10) Pub. No.: US 2002/0045506 A1
(43) Pub. Date: Apr. 18, 2002

(54) Actuating device for a variable transmission, especially for preselecting the range of an automatic transmission

(76) Inventor: Ulf Scheuerer, Regensburg (DE)

Correspondence Address: BAKER & BOTTS, 30 ROCKEFELLER PLAZA, NEW YORK, NY, 10112

(21) Appl. No.: 09/957,580

(22) Filed: Sep. 20, 2001

(30) Foreign Application Priority Data
Sep. 20, 2000 (DE) 100 465 89.7

(51) Int. Cl. F16H 59/08

(52) U.S. Cl. 475/5; 475/7

(57) ABSTRACT

An actuating device for a variable transmission, in particular for setting one of a number of preselected ranges of an automatic transmission in a motor vehicle, having an intermediate gear for transmitting the actuating motion produced by a first mechanical control element (EM) to a selector element (BW) of the variable transmission, the intermediate gear being connected not only to the first control element but also to a second mechanical control element to enable the transmission to be set at least in part even if the first control element fails.

### FIELD OF THE INVENTION

The invention relates to an actuating device for a variable transmission, in particular for setting at least one of a number of preselected ranges of an automatic transmission in a motor vehicle.

### BACKGROUND OF THE INVENTION

Automatic transmissions for passenger cars generally have four preselected ranges for the different operating states of the passenger car, namely a park position, a reverse position, a neutral position and a drive position. In the park position, the automatic transmission is locked, with the result that the output shaft of the transmission and hence the wheels cannot rotate and thereby preventing the car from rolling away accidentally. When parking a passenger car fitted with an automatic transmission, care must therefore be taken to ensure that the automatic transmission assumes the park position. Normally, this is accomplished by the driver of the passenger car moving a selector lever into the park position, the movement of the selector lever being transmitted to the automatic transmission mechanically by means of a linkage or Bowden cable.

The prior art also includes an electronically controlled automatic transmission in which the connection between the selector lever and the automatic transmission is not provided mechanically by a linkage or a Bowden cable but by electric lines, with the mechanical setting of the automatic transmission being performed by an electric motor, for example. However, this principle, which is also referred to as “shift by wire”, has the disadvantage that it is not possible to set the automatic transmission if the power supply fails. There is therefore the risk that the automatic transmission will remain in the drive position if the power fails, thus allowing the passenger car to roll away when parked.

DE 691 00 216 T2 discloses an actuating device for an automatic transmission that has two electric motors as control elements for setting the desired preselected range of the automatic transmission. Power is transmitted from the two electric motors to the selector element of the automatic transmission by a planetary gear. One electric motor acts on the sun wheel while the other electric motor acts on the planet wheel, thereby allowing the annulus of the planetary gear which acts on the selector element of the automatic transmission to be rotated by either electric motor independently of the other. In this case, therefore, it is still possible to set the desired preselected range even if one of the two electric motors fails.

The aforesaid actuating device further permits setting of the desired preselected range within the scope of an emergency mode, even if there is a complete power failure. For this purpose, the planetary gear is decoupled from the selector element of the automatic transmission by a clutch mechanism and then actuated by means of a manual drive mechanism. Nevertheless, the disadvantage with this known actuating device is the fact that a relatively large amount of force is required to set the desired preselected range in the emergency mode when the power supply has failed.

### SUMMARY OF THE INVENTION

The object of the present invention is to improve the known actuating device described above in such a way that it is possible to set the desired preselected range with as little force as possible even when the power supply fails. Accordingly, the present invention comprises the general technical teaching of providing two separate mechanical control elements for setting the automatic transmission, thus allowing the automatic transmission to be set even if one of the two control elements fails or there is a defined fault. More specifically, the first control element for setting the automatic transmission is electrically operated, whereas the other control element for setting the automatic transmission is operated in a purely mechanical manner. Such a difference in the design of the two control elements has the advantage that a defined setting of the automatic transmission is still possible even if the power supply for the electrically operated control element fails. An electric motor or an electromagnetic actuator is preferably used as the electrically operated control element. The control element operated in a purely mechanical manner, on the other hand, is preferably a spring energy store, which can have a leg spring or a spiral spring as an energy storage device, for example.

In the preferred embodiment of the present invention, an intermediate gear is arranged between the two control elements and the selector element of the variable transmission. The intermediate gear has a locking mechanism that connects the first control element and/or the second control element to the selector element of the variable transmission. This allows either of the two control elements to perform the setting of the transmission. The locking mechanism is preferably electrically operated, and connects the selector element of the variable transmission (a) to the electrically operated first control element when the power supply is operational and (b) to the second control element, which is operated in a purely mechanical manner, if there is no power supply or there is a fault. In normal operation with the power supply operational, the transmission is thus set by means of the electrically operated control element, while the control element that is operated in a purely mechanical manner only comes into effect if the power supply fails. The intermediate gear for transmitting the actuating movement of the control elements to the selector element of the variable transmission is preferably a planetary gear with an annulus, a sun wheel and a planet wheel. In this arrangement, the first control element is preferably connected to the sun wheel, while the second control element and the locking mechanism are preferably connected to the annulus. The planet wheel, on the other hand, is preferably connected to the selector element of the variable transmission.

In a further preferred embodiment of the present invention, the first, electrically operated control element is an electric motor with a self-locking worm. This has the advantage that the sun wheel driven by the electric motor is locked if the power supply fails and can no longer rotate.

### BRIEF DESCRIPTION OF THE DRAWINGS

The invention is described in greater detail below in the context of a preferred exemplary embodiment of the invention and with reference to:

FIG. 1 which shows an actuating device according to the invention for an automatic transmission with a planetary gear.

### DETAILED DESCRIPTION OF THE INVENTION

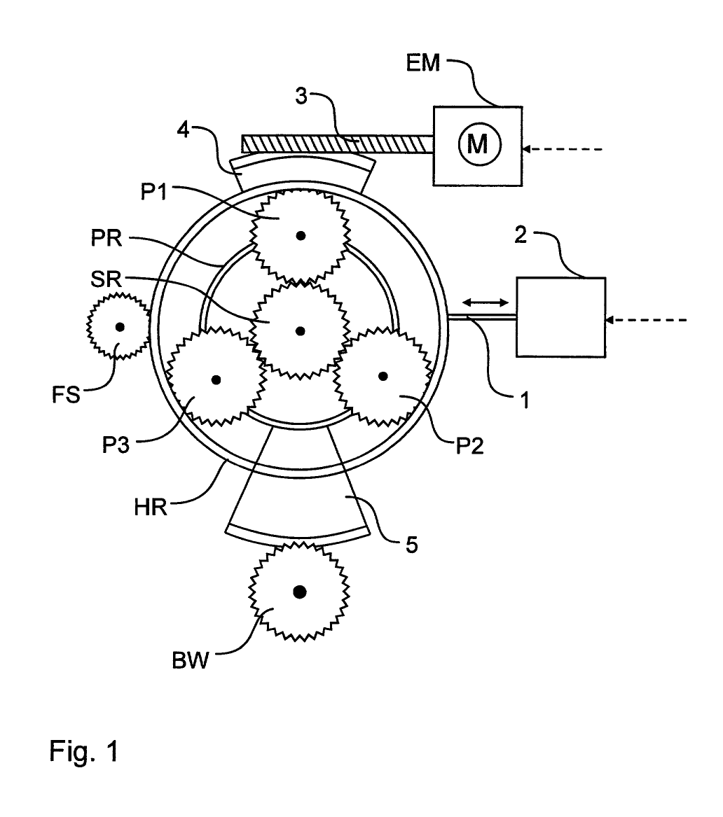

The actuating device according to the present invention as illustrated in FIG. 1 makes it possible to select one of a number of preselected ranges of an automatic transmission for a passenger car, so that it is possible to operate the automatic transmission optionally in a park position, a reverse position, a neutral position or a drive position. The preselected range of the automatic transmission is specified by means of a shaft BW, which is used as a selector element for the automatic transmission and the angle of rotation of which specifies the preselected range of the automatic transmission.

To select the desired preselected range of the automatic transmission, the driver of the passenger car actuates a selector lever (not illustrated for the sake of simplicity), the position of the selector lever being transmitted by electric lines to a control unit that activates an electric motor EM in such a way that the shaft BW assumes the position corresponding to the desired preselected range, as described in detail below.

Power is transmitted from the electric motor EM to the shaft BW by means of a planetary gear, also referred to as an epicyclic gear, which is used as an intermediate gear. The planetary gear essentially comprises an annulus HR with internal toothing, a sun wheel SR with external toothing arranged rotatably in the center of the annulus HR and a planet wheel PR, which is arranged in the space between the annulus HR and the sun wheel SR and which supports three rotatably mounted planets P1, P2, P3. Planetary gears of this kind are well known and are described, for example, in Dubbel; Taschenbuch füir den Maschinenbau [Mechanical Engineering Handbook], 15th edition, page 475. Accordingly, it is not necessary to provide a detailed description below of the operation of the planetary gear, but instead applicant relies on the aforesaid teaching known in this art which is incorporated herein by reference.

In addition to the internal toothing, the annulus HR also has external toothing, which allows the annulus HR to be locked. For this purpose, a catch 1, which can be moved in an essentially radial direction by an electromagnetic actuator 2 to either lock or release the annulus HR, is arranged on the outside of the annulus. During the normal operation of the automatic transmission when the power supply is operational, the actuator 2 locks the annulus HR by means of the catch 1, preventing it from rotating.

The electric motor EM has a worm 3, which engages in external toothing on a lever 4 firmly connected to the sun wheel SR, allowing the electric motor EM to rotate the sun wheel SR by means of the worm 3 and the lever 4.

With the annulus HR fixed, the rotation of the sun wheel SR is transmitted via the planets P1, P2, P3 to the planet wheel PR, with the result that, during normal operation with the power supply operational and the annulus HR consequently locked, the electric motor EM can rotate the planet wheel PR. The planet wheel PR, in turn, is firmly connected to another lever 5, which has on its outside external toothing that engages the external toothing on the shaft BW. During normal operation with the power supply operational, the electric motor EM can thus rotate the shaft BW by means of the interposed planetary gear and thus determine the preselected range of the automatic transmission. The planetary gear and the worm 3 are advantageous since it is possible to apply torques of up to 12 Nm via the shaft BW to set the preselected range, it being necessary to make the electric motor EM as small as possible owing to the restricted space conditions.

The operation of the actuating device according to the present invention in the event of a power supply failure will now be described. In this case, the electric motor EM stops and the worm 3 locks the lever 4, with the result that the sun wheel SR is fixed. The failure of the power supply also leads to unlocking of the annulus HR by the actuator 2 and the catch 1, thus allowing the annulus HR to rotate freely. A gearwheel FS engages the external toothing of the annulus HR. The gearwheel FS is preloaded by a spiral spring, which rotates the annulus HR in a direction required to set the automatic transmission to the park position. Because the sun wheel SR is fixed, this rotation of the annulus HR is transmitted to the planet wheel PR by the planets P1, P2, P3, the rotation of the planet wheel PR in turn being transmitted by the lever 5 to the shaft BW. If the power supply fails, the rotation of the spring-loaded gearwheel FS is thus transmitted to the shaft BW by the planetary gear, thereby setting the automatic transmission to the park position.

If the power supply fails, the rotation of the gearwheel FS leads to relief of the spring and hence the discharge of the spring energy store. Once the power supply has been re-established, the spring energy store must therefore be recharged in order to allow emergency operation if there is another power failure. For this purpose, the actuator 2 and the annulus HR are unlocked for a predetermined period of time even after the power supply has been re-established, and the electric motor EM rotates the sun wheel SR by means of the worm 3 and the lever 4. The rotation of the sun wheel SR during the recharging of the spring energy store is transmitted directly to the annulus HR by the planets P1, P2, P3 since the shaft BW is fixed in the park position of the automatic transmission, preventing the planet wheel PR from rotating. During the recharging of the spring energy store after an interruption to the power supply, the electric motor EM thus rotates the gearwheel FS by means of the worm 3, the lever 4, the planets P1, P2, P3 and the annulus HR, thereby reloading the spring connected to the gearwheel FS.

The present invention is not to be understood as limited by the preferred exemplary embodiment described above. On the contrary, a large number of variants and modifications that make use of the inventive idea and therefore likewise fall within the scope of protection is conceivable.

I claim:

1. An actuating device for a variable automatic transmission in a motor vehicle for setting at least one of a number of preselected ranges of the transmission comprising at least one intermediate gear for transmitting the actuating motion produced by a first control element to a selector element of the variable transmission, the intermediate gear being connected to the first control element and also to a second control element so as to enable the transmission to be set at least in part even if the first control element fails, wherein the intermediate gear is arranged between the two control elements and the selector element of the variable transmission in order to transmit the actuating motion of either of the two control elements to the selector element, further wherein the first control element is electrically operated via a power supply, and the second control element is operated mechanically via a spring as an energy storage device, thereby enabling the transmission to be set at least in part even if the power supply for the first control element malfunctions,

2. The actuating device according to claim 1, wherein the spring is a spiral spring or a leg spring.

3. The actuating device according to claim 1, wherein the intermediate gear has a locking mechanism that connects the first control element and/or the second control element to the selector element of the variable transmission.

4. The actuating device according to claim 3, wherein the locking mechanism is electrically operated, and the locking mechanism connecting the selector element of the variable transmission to the electrically operated first control element when the power supply is operational and to the second control element in the event of a power malfunction.

5. The actuating device according to claim 1, wherein the intermediate gear is a planetary gear with an annulus, a sun wheel and a planet wheel.

6. The actuating device according to claim 5, wherein the first control element is connected to the sun wheel and the second control element and the locking mechanism are connected to the annulus while the planet wheel is connected to the control element of the variable transmission.

7. The actuating device according to claim 6, wherein the electrically operated first control element has a self-locking worm that locks the sun wheel if the power supply fails.

8. The actuating device according to claim 6, wherein the electrically operated first control element is connected to the sun wheel indirectly by means of a further intermediate gear.

9. The actuating device according to claim 5, wherein the planet wheel is connected to the control element of the variable transmission indirectly by means of a further intermediate gear.

10. The actuating device according to claim 1, wherein the electrically operated first control element is an electric motor or an electromagnetic actuator.
